(19) United States
(12) Patent Application Publication
(10) Pub. No.: US 2026/0231177 A1
(43) Pub. Date: Aug. 6, 2026

(54) DOWNLINK CONTROL INFORMATION FOR MULTI-TRANSPORT BLOCK SCHEDULING

(71) Applicant: QUALCOMM Incorporated, San Diego, CA (US)

(72) Inventors: Syed Hashim Ali SHAH, Littleton, MA (US); Ayan SENGUPTA, Mountain View, CA (US); Alberto RICO ALVARINO, San Diego, CA (US)

(21) Appl. No.: 19/407,584

(22) Filed: Dec. 3, 2025

Related U.S. Application Data
(60) Provisional application No. 63/752,101, filed on Jan. 31, 2025.

(51) Int. Cl. H04W 72/232; H04L 5/00

(52) U.S. Cl. CPC H04W 72/232; H04L 5/0007; H04L 5/0044

(57) ABSTRACT

Certain aspects of the present disclosure provide techniques for wireless communications by a device. A method generally includes receiving a downlink control information message that schedules a plurality of transport blocks and indicates an orthogonal cover code configuration for the plurality of transport blocks, and transmitting the plurality of transport blocks using the orthogonal cover code configuration.

### CROSS REFERENCE TO RELATED APPLICATION(S)

The present Application for Patent claims priority to and benefit of U.S. Provisional Patent Application No. 63/752,101, filed Jan. 31, 2025, which is hereby expressly incorporated by reference herein in its entirety.

### INTRODUCTION

### Field of the Disclosure

Aspects of the present disclosure relate to wireless communications, and more particularly, to techniques for transmitting downlink control information to schedule multiple transport blocks with orthogonal cover codes.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes receiving a downlink control information (DCI) message that schedules a plurality of transport blocks (TBs) and indicates an orthogonal cover code (OCC) configuration for the plurality of TBs; and transmitting the plurality of TBs using the OCC configuration.

Certain aspects provide a method for wireless communications by a network entity (NE). The method includes sending, to a UE, a DCI message that schedules a plurality of TBs and indicates an OCC configuration for the plurality of TBs; and receiving the plurality of TBs in accordance with the OCC configuration from the UE.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of an orthogonal cover code scheme for wireless communications.

FIG. 6 depicts a diagrammatic view of an example transmission scheme for scheduling multiple transport blocks using a single DCI message.

FIG. 7 depicts a diagrammatic view of a transmission scheme used to send a DCI message to schedule multiple transport blocks and indicate an orthogonal cover code configuration.

FIG. 8 depicts a diagrammatic view of a transmission scheme used to send a DCI message to schedule multiple transport blocks and indicate an orthogonal cover code configuration.

FIG. 9 depicts a diagrammatic view of a transmission scheme used to send a DCI message to schedule multiple transport blocks and indicate an orthogonal cover code configuration.

FIG. 10 depicts a process flow for communications in a network between a network entity and a user equipment for transmitting downlink control information to schedule multiple transport blocks with orthogonal cover codes.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for transmitting downlink control information to schedule multiple transport blocks.

As wireless communication systems grow, an increasing number of wireless apparatuses (e.g., user equipments (UEs)) communicate with a predefined set of time-frequency resources. Multiple access schemes, such as multiplexing multiple UEs, can increase the number of UEs within the same amount of time-frequency resources. However, multiplexing multiple UEs may create interference between signals from the multiple UEs at base stations. Orthogonal cover codes (OCCs) can mitigate the interference. For example, during a transmission timeframe, T, a UE is assigned a fixed OCC so that data from the UE is cover coded in an orthogonal manner with respect to data from one or more other UEs.

In some wireless communications systems, such as in a narrowband Internet of Things (NB IoT) system, a UE may transmit multiple transport blocks over a narrowband physical uplink shared channel (NPUSCH) for transmitting uplink data and control information from IoT devices to the network entity. A “transport block” refers to a packet of data or control information transmitted between a physical layer and higher layers of a wireless communication system. A network entity may send a downlink control information (DCI) message to the UE for each transport block being sent. As used herein, a “DCI message” refers to a control message sent by a network entity to a UE over a narrowband physical downlink control channel (NPDCCH). A DCI message may include scheduling instructions and parameters (e.g., allocated resources, modulation and coding schemes, antenna port configuration, etc.) associated with one or more transport blocks. In some cases, a DCI message can schedule multiple TBs. This is referred to as multi-TB scheduling.

In some cases, multiple UEs may communicate at the same time. For example, a first UE may transmit a first set of transport blocks (which may, for example, include two transport blocks) and a second UE may transmit, at the same time as the transmission of the first set of transport blocks, a second set of transport blocks. The multiple transport blocks may be multiplexed in time, causing interference between signals from the multiple multiplexed UEs communicating with the network entity. As mentioned, OCC can mitigate this interference. However, explicitly indicating different OCC configurations for different UEs has traditionally involved transmitting separate DCI message for each transport block at each UE. For example, a network entity may send 2 DCI messages for scheduling 2 transport blocks being transmitted by a first UE, and 2 additional DCI messages for scheduling 2 additional transport blocks being transmitted by a second UE. Sending a separate DCI message for scheduling each transport block increases downlink control channel overhead. As mentioned, this overhead can be mitigated by multi-TB scheduling, but behavior of OCC indication for multi-TB scheduling may be undefined. Without a common understanding of OCC indication for multi-TB scheduling, communications between a UE (e.g., an NB IoT UE) and a network entity may fail.

Accordingly, a technical problem arises with respect to how to structure or configure a DCI message for scheduling a plurality of transport blocks (e.g., a DCI message scheduling a multi-TB transmission) for NPUSCH transmissions that are multiplexed in time with transmissions of other UEs, such as to facilitate OCC configuration for such transmissions. Certain aspects herein provide a technical solution to this technical problem, such as by providing techniques for receiving a DCI message that schedules a plurality of transport blocks and indicates an OCC configuration for the plurality of TBs. As used herein, “OCC configuration” refers to an indication of an OCC factor and an OCC codeword for one or more transport blocks being scheduled. As used herein, an “OCC factor” refers to a length of an orthogonal cover code which is greater than or equal to a number of UEs multiplexed. In some examples, OCC can increase duration of transmitted signals by a multiplexing factor of M where M is the number of UEs multiplexed. As used herein, “OCC codeword” refers to a predefined sequence from an orthogonal set of sequences that can be used to differentiate overlapping signals of data streams sharing the same physical resources. For example, a UE may receive a DCI message that schedules multiple transport blocks. The DCI message may indicates an OCC configuration for the multiple transport blocks. DCI messages that schedule multiple transport blocks in accordance with described aspects reduce the number of DCI messages used for scheduling, thereby providing the technical benefit of reducing downlink control channel overhead. Described DCI messages that indicate an OCC configuration for multiple scheduled transport blocks further ensure orthogonality between signals originating from different multiplexed UEs. The indicated OCC configuration thus mitigates interference experienced at a network entity, thereby providing the benefit of improving throughput at the UEs. Improved throughput is further enhanced for UEs in extended coverage that include more repetitions. Certain described aspects further provide rules for how the OCC configuration indicated in a DCI message are applied to multiple transport blocks scheduled by the DCI message. The provided rules define different mechanisms for how to signal the OCC configuration indicated in the DCI message. Examples of mechanisms used to signal OCC configurations in accordance with described aspects are provided below.

In some examples, the DCI message indicating the OCC configuration includes a value indicating an OCC codeword for all transport blocks scheduled. For example, a network entity may send a UE a DCI message including a value indicating an OCC codeword represented as “0” to be applied to each of a first and second transport block scheduled by the DCI message. The DCI message schedules multiple transport blocks while indicating an OCC codeword that ensures orthogonality between the data stream of the UE and data streams of any additional multiplexed UEs communicating with a shared network entity. The DCI message thus reduces the total number of DCI messages used to schedule multiple transport blocks, thereby providing the technical benefit of reducing downlink control channel overhead at the network entity. The DCI message further provides an OCC configuration including an OCC codeword that mitigates interference, thereby providing the technical benefit of improving throughput at the UE (and one or more multiplexed UEs).

In other examples, the DCI message indicating the OCC configuration includes a set of one or more bits, where each bit indicates a respective OCC codeword for each respective transport block being scheduled by the DCI message. For example, a network entity may send a DCI message including a first bit that indicates a first codeword represented as “0” for a first scheduled transport block, and a second bit that indicates a second codeword represented as “1” for a second scheduled transport block. The DCI message schedules multiple transport blocks while indicating individual OCC codewords for each scheduled transport block, thereby ensuring orthogonality between the data stream of the UE and data streams of any additional multiplexed UEs communicating with a shared network entity. The DCI message thus reduces the total number of DCI messages to schedule multiple transport blocks, thereby providing the technical benefit of reducing downlink control channel overhead at the network entity. The DCI message further indicates an OCC configuration including OCC codewords that mitigate interference, thereby providing the technical benefit of improving throughput at the UE (and one or more multiplexed UEs). The DCI message further indicates an OCC configuration that creates time diversity by alternating codewords between transport blocks, thereby providing the technical benefit of improving reliability and mitigating fading effects due to different codewords experiencing varying channel conditions. The DCI message indicating individual codewords for each of the multiple scheduled transport blocks increases flexibility in tailoring the codewords to each transport block, thereby providing the technical benefit of increasing link reliability due to improved mitigation of interference.

In yet another example, the DCI message indicates an OCC configuration further including a codeword hopping pattern indicating a sequence of OCC codewords for multiple scheduled transport blocks. As used herein, a “codeword hopping pattern” refers to a pattern indicating a sequence of OCC codewords that may be applied to each sequential transport block in a set of multiple transport blocks being scheduled. For example, a network entity may send a UE a DCI message including an OCC configuration that indicates (e.g. using one or more bits) a codeword hopping pattern. The codeword hopping pattern may indicate a sequence of OCC codewords to apply to each TB of a set of TBs. The DCI message schedules multiple transport blocks and includes a value (e.g., one or more bits) that indicates the codeword hopping pattern to be used to apply individual codewords for each of the multiple transport blocks. Using a singular DCI message including one or more bits that indicates a codeword hopping pattern reduces the amount of signaling as compared to explicitly assigning individual codewords to each of the scheduled transport blocks, thereby providing the benefit of reducing overhead. The OCC codewords applied to each scheduled transport block in accordance with the indicated codeword hopping pattern ensure orthogonality between the data stream of the UE and data streams of any additional multiplexed UEs. The DCI message thus reduces interference, thereby providing the technical benefit of improving throughput at the UE (and one or more multiplexed UEs). The reduced total number of DCI messages to schedule multiple transport blocks provides the technical benefit of reducing downlink control channel overhead at the network entity. The DCI message further indicates an OCC configuration that creates time diversity based on applied codeword hopping patterns that apply different codewords between transport blocks, thereby providing the technical benefit of improving reliability and mitigating fading effects due to different codewords experiencing varying channel conditions.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

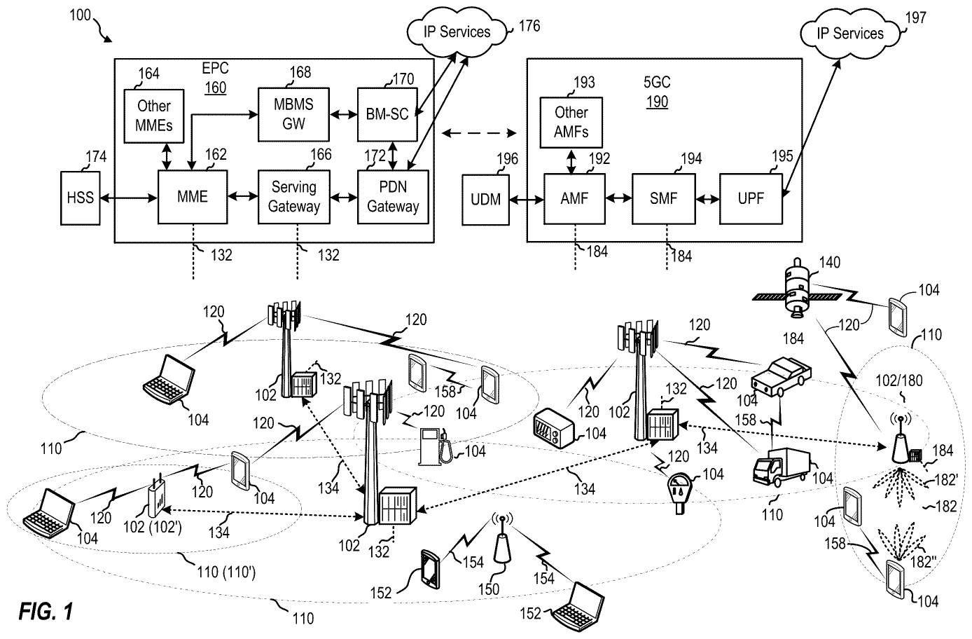

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

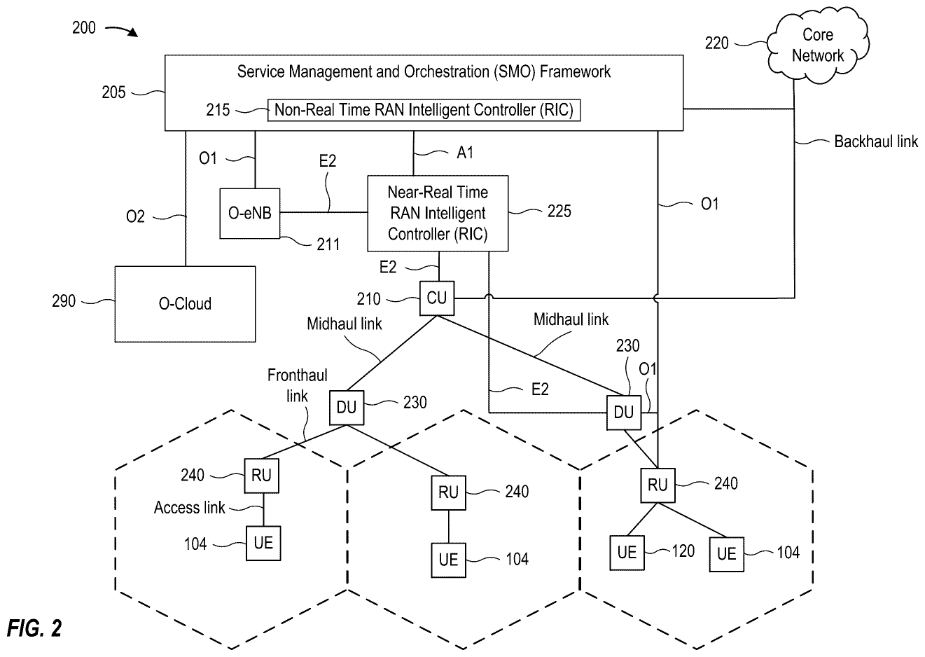

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR 2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

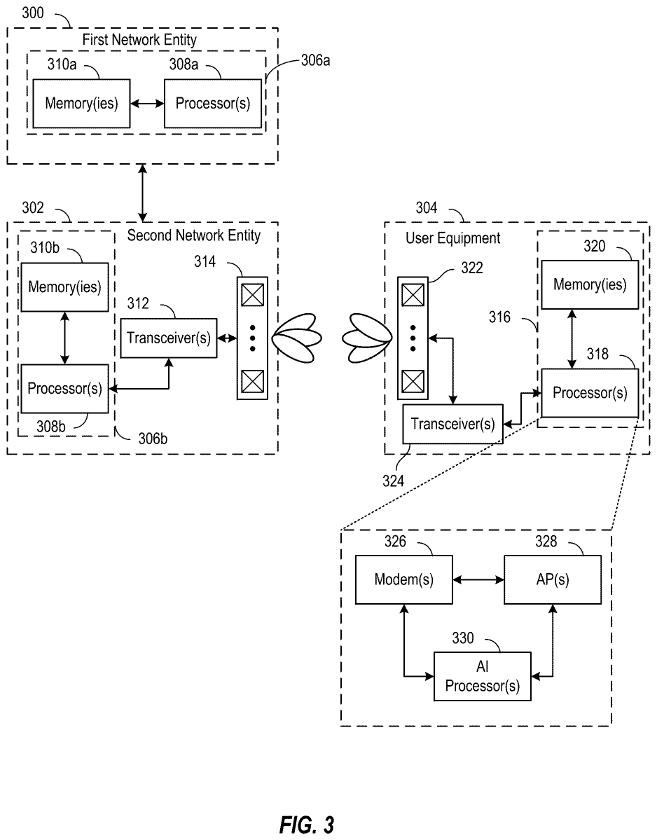

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

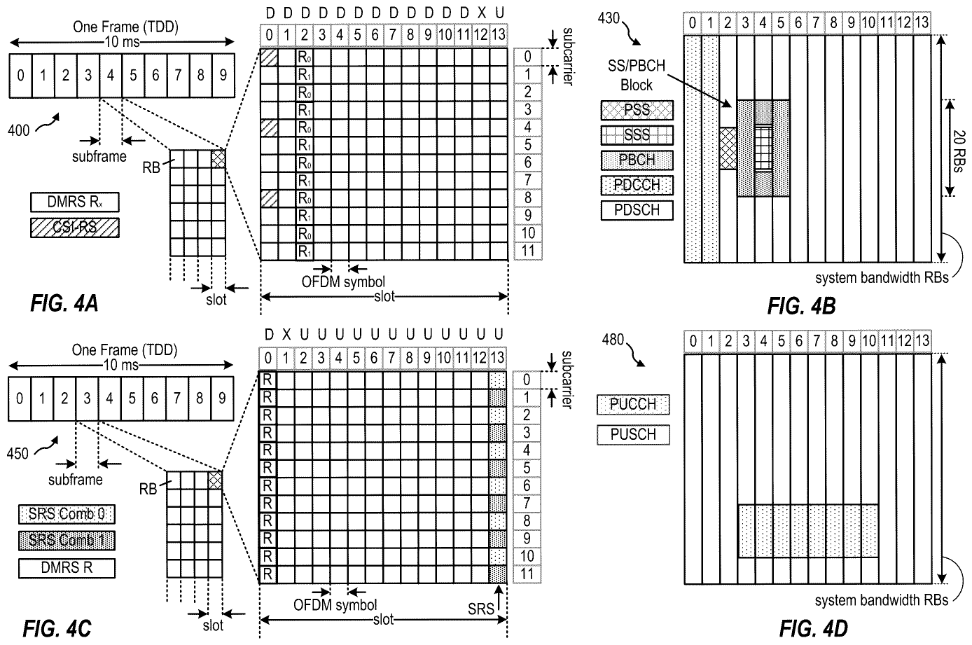

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### ASPECTS RELATED TO TRANSMITTING DOWNLINK CONTROL INFORMATION TO SCHEDULE MULTIPLE TRANSPORT BLOCKS WITH ORTHOGONAL COVER CODES

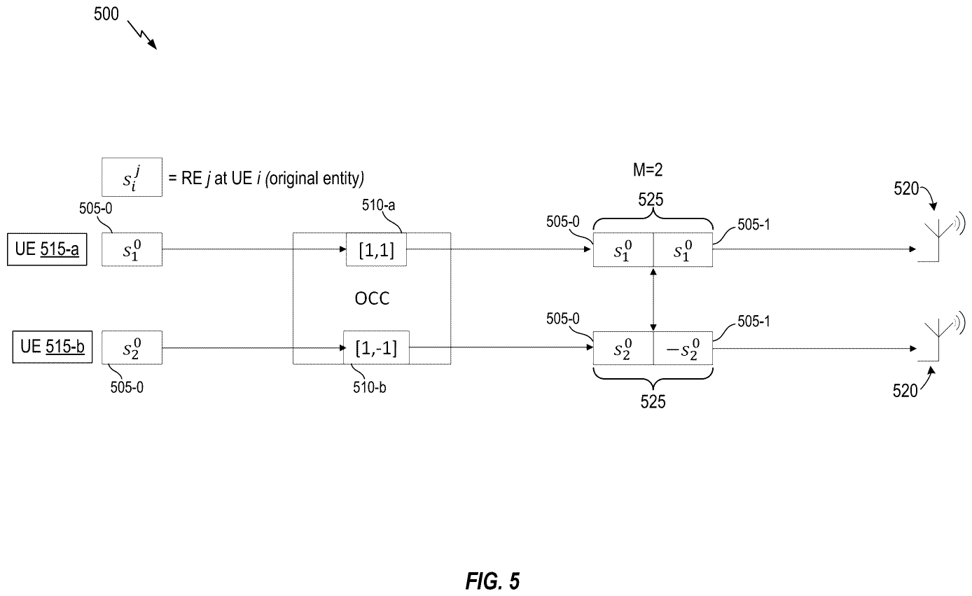

FIG. 5 shows an example of an OCC scheme 500 that supports techniques for OCC with transport blocks over multiple slots (TBoMS) and resource unit (RU) allocation. In some cases, the OCC scheme 500 may support or be supported by aspects of the wireless communications network 100 described with reference to FIG. 1. In some aspects, the network entity 520 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, a UE 515 (e.g., UE 515-a or UE 515-b) may be an example of UE 104 depicted and described with respect to FIG. 1 or the UE 304 depicted and described with respect to FIG. 3. However, in other aspects, UE 515 may be another type of wireless communications device and network entity 520 may be another type of network entity or network node, such as those described herein.

In some implementations, OCC techniques may be utilized to reduce interference at the network entity 520 when uplink communications from multiple UEs, such as the first UE 515-a and the second UE 515-b, are multiplexed. For instance, when the uplink communications of the first UE 515-a and the second UE 515-b are multiplexed, the uplink communications may share the same uplink time and frequency resources. Accordingly, the first UE 515-a and the second UE 515-b may transmit on the shared resources at the same time. In such cases, the network entity 520 may receive a summation or a super-imposition of the signals from the UEs. In some cases, the multiplexed signal may result in interference at the network entity 520. To mitigate such interference, the network entity 520 may configure each of the multiplexed UEs to use an assigned OCC codeword to cover code their respective uplink transmission. The cover coding may cause data transmissions from each of the multiplexed UEs 515 to be orthogonal to one another.

When the network entity 520 receives a multiplexed cover coded transmission from the multiplexed UEs, the network entity 520 may use the assigned OCC codewords to separate the super-imposed multiplexed signal to identify which portion of the signal was transmitted from which UE. For instance, by decoding the received multiplexed signal with the OCC codeword assigned to a particular UE, such as the first UE 515-a, the network entity 520 may be able to retrieve, from the multiplexed signal, the specific signal transmitted by the first UE 515-a. Likewise, by decoding the multiplexed signal with the OCC codeword assigned to the second UE 515-b, the network entity 520 may be able to retrieve the specific signal transmitted by the second UE 515-b.

Use of OCC may result in spreading of an entity over multiple entities, e.g., M entities, where M may represent an OCC factor (e.g., an OCC order), sometimes referred to as a multiplexing factor (e.g., a quantity of multiplexed UEs). The entity may be a resource element (e.g., a sub-carrier), a slot, an OFDM symbol, a cluster, an RU, etc., and may be determined based on a type of OCC being performed, such as OCC across slots, within OFDM symbols, across OFDM symbols, across clusters, etc. Accordingly, a transmission originally allocated to one entity (e.g., one resource element) may be spread to a quantity of entities that is equal to the OCC factor (e.g., a quantity of UEs being multiplexed). By way of example, when the first UE 515-a and the second UE 515-b are multiplexed (e.g., M=2), an entity (e.g., a slot or an RU) associated with the first UE 515-a and an entity associated with the second UE 515-b may be spread into 2 respective entities using a respective OCC codeword assigned to each of the UE 515 by the network entity 520.

In the example of FIG. 5, the uplink transmissions of the first UE 515-a and the second UE 515-b may be multiplexed. The UEs 515 may share uplink time and frequency resources, such as a slot 505-0. To mitigate interference caused by sharing slot 505-0, the network entity 520 may assign, to the first UE 515-a, a first OCC codeword 510-a of [1,1] for cover coding transmissions from the first UE 515-a, and may assign, to the second UE 515-b, a second OCC codeword 510-b of [1, −1] for cover coding transmissions from the second UE 515-b. The first OCC codeword 510-a and the second OCC codeword 510-b may be orthogonal to one another. Accordingly, a first transmission (e.g., s₁⁰) from the first UE 515-a at slot 505-0 may be cover coded with the first OCC codeword 510-a (e.g., [1,1]), resulting in the original first transmission (e.g., s₁⁰) being spread (e.g., s₁⁰, s₁⁰) into 2 slots, such as the original slot 505-0 and an additional slot 505-1, (collectively, spread slots 525 having a factor of 2 (e.g., M=2)). Further, a second transmission (e.g., s₂⁰) from the second UE 515-b at slot 505-0 may be cover coded with the second OCC codeword 510-b (e.g., [1,-1]), resulting in the original second transmission (e.g., s₂⁰) being spread (e.g., s₂⁰, −s₂⁰) into 2 slots, such as the slot 505-0 and the additional slot 505-1, (collectively, spread slots 525 having a factor of 2 (e.g., M=2)). It should be noted that the horizontal axis in FIG. 5 does not represent time, but rather generally represents an OCC procedure starting at a UE 515 with an entity (e.g., RE j), applying cover coding to the entity at 510, spreading the entity to two entities at spread slots 525, and transmitting the two entities for reception at a network entity 520.

Accordingly, when the first and second transmissions from the first UE 515-a and the second UE 515-b, respectively, are spread across the spread slots 525, the transmissions may occupy the same time and frequency resources (e.g., may be multiplexed). However, because the OCC codewords assigned to each of the first UE 515-a and the second UE 515-b are orthogonal to one another, the spread first and second transmission may also be orthogonal to each other. The network entity 520 may use the respective codewords to decode the multiplexed transmissions from first UE 515-a and the second UE 515-b and receive the corresponding transmissions.

In some implementations, OCC may be used with TBoMS transmissions or uplink NB-IoT transmissions (e.g., a narrowband PUSCH (NPUSCH)). In such cases, the network entity 520 may employ constraints to ensure that a sufficient quantity of time resources (such as slots, RUs, or other time units) are allocated to support the spreading of data across multiple entities or resource elements when OCC is utilized. For instance, the network entity 520 may employ constraints related to how a quantity of repetitions (e.g., K for TBoMS and Nᵣₑₚ for NB-IoT) is determined for each TBoMS transmission or for each NB-IoT transmission. The network entity 520 may employ constraints related to how a quantity of time units (e.g., N for TBoMS or N_{RU} for NB-IoT) is determined for each TBoMS transmission repetition or for each NB-IoT transmission repetition. In cases when a sufficient quantity of time resources is not allocated, a UE 515 may have to split a single time resource (e.g., split a slot, a RU, or other time unit) to support the spreading caused by OCC. In such cases, a channel coding rate may be negatively impacted, which in turn may negatively impact throughput at the network. Accordingly, by ensuring that sufficient resources are available to support such spreading, the benefits of OCC may be realized.

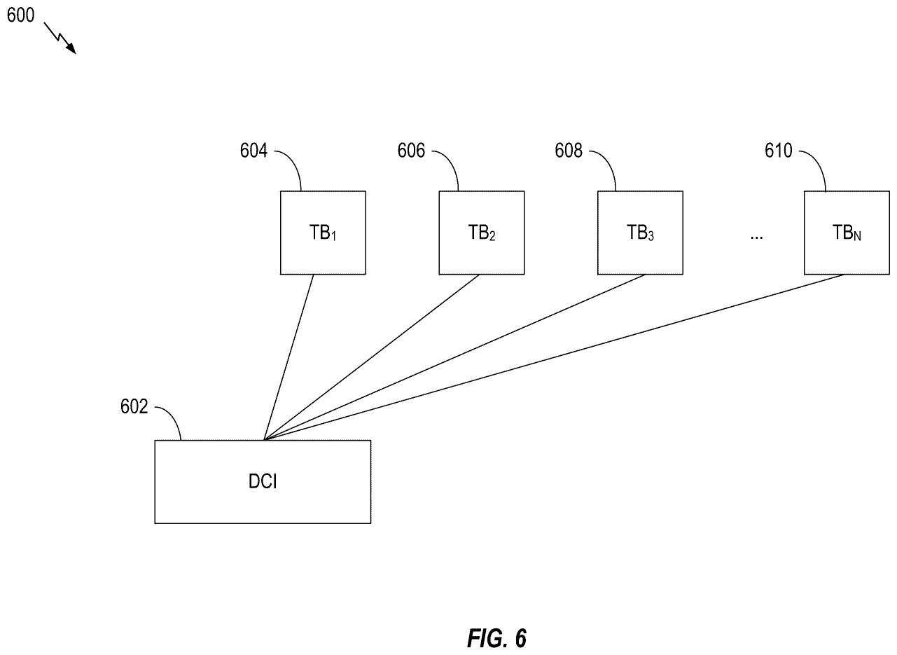

FIG. 6 depicts a diagrammatic view of an example transmission scheme 600 for scheduling multiple TBs using a single DCI message. As an example, DCI message 602 may be sent by a network entity to a UE for scheduling multiple TBs. DCI message 602 may be sent by a network entity such as an example BS 102 depicted and described with respect to FIG. 1, the first network entity 300 or the second network entity 302 depicted and described with respect to FIG. 3, or a disaggregated base station depicted and described with respect to FIG. 2. DCI message 602 may be configured to schedule multiple transport blocks, such as transport block “TB₁” 604, transport block “TB₂” 606, transport block “TB₃” 608, and continuing up to a transport block “TB_{N}” 610. In example 600, N is greater than or equal to 2. In some examples, DCI message 602 is sent by a network entity to schedule up to 2 TBs for a UE communicating NB-IOT transmissions.

For communications using NB-IoT, DCI messages may be used for scheduling multiple TBs on the NPUSCH. In some examples, scheduling is performed using DCI format N0 which specifies uplink resource assignments and other key parameters such as modulation, coding schemes, and resource allocation for data transmission. DCI messages for scheduling multiple TBs may further include bits for conveying detailed instructions to a UE. In some examples, the number of scheduled TBs for unicast may be encoded in the DCI. In other examples, the DCI message may include a bit that serves as a new data indicator to distinguish between new TBs and retransmissions. In other examples, the DCI message may include a bit for HARQ process numbers that are mapped in the DCI to link each scheduled TB to a corresponding HARQ context.

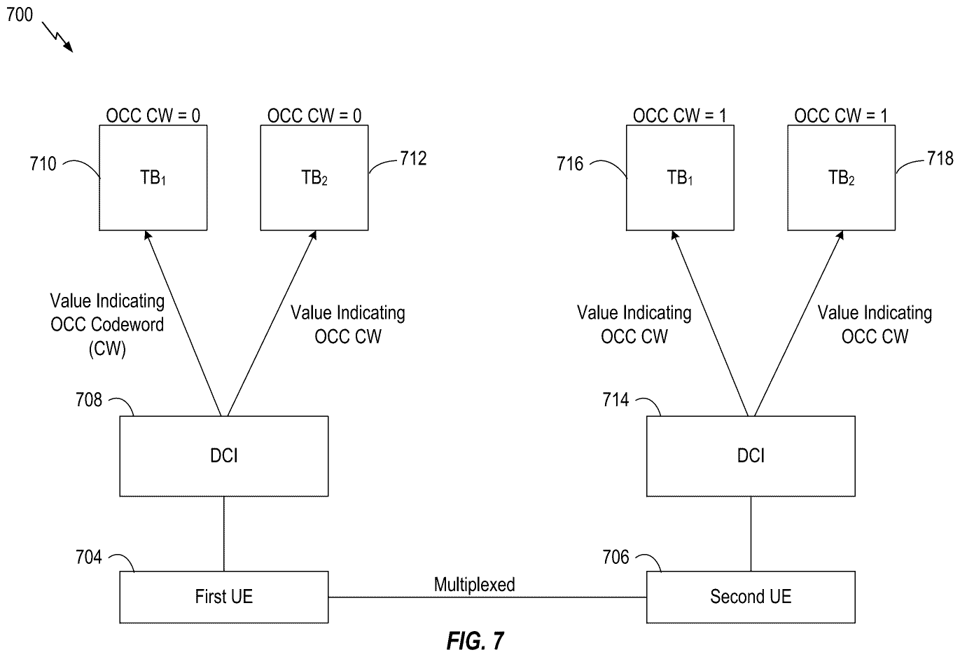

As discussed, conventional transmission schemes in which a network entity sends a separate DCI message for scheduling each TB increases downlink control channel overhead. Accordingly, transmission scheme 600 provides the technical benefit of reducing overhead by enabling multi-TB scheduling. However, ambiguity may arise with regard to mechanisms for signaling OCC indications for multi-TB scheduling. Without a common understanding of OCC indications for multi-TB scheduling, communications between a UE (e.g., an NB IoT UE) and a network entity may fail due to unmitigated interference and a lack of orthogonality of transmissions to the network entity. Certain aspects herein provide a technical solution to this technical problem, such as by providing techniques for communicating of a DCI message that schedules a plurality of TBs and also indicates an OCC configuration for the plurality of TBs. Indicating an OCC configuration for the plurality of TBs mitigates interference, thereby providing the technical benefit of improving throughput at the UE (and one or more multiplexed UEs). Transmission schemes that provide an OCC configuration in a DCI message for scheduling multiple TBs in accordance with aspects described are discussed in greater detail below with reference to FIGS. 7-9.

### EXAMPLE TRANSMISSION SCHEMES INCLUDING A DCI MESSAGE FOR MULTI-TB SCHEDULING WITH OCC

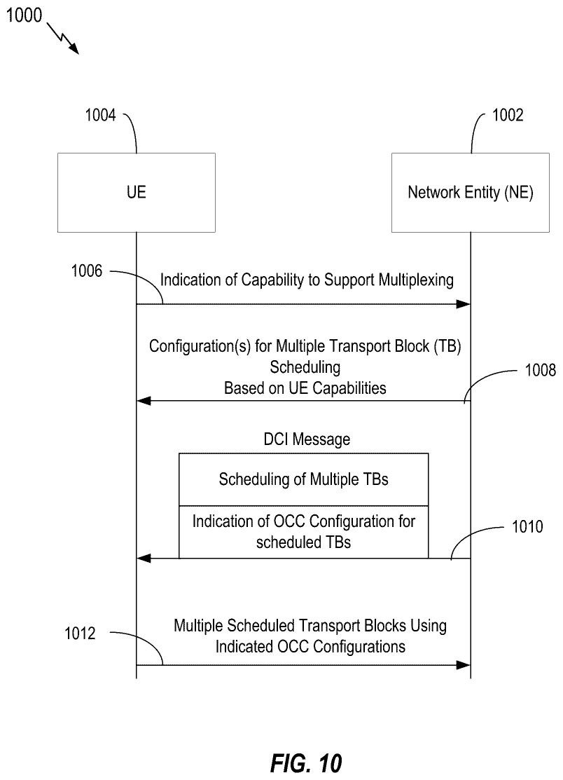

Examples transmission schemes discussed below may involve a network entity sending signaling to one or more multiplexed UEs to enable multi-TB scheduling and OCC. Signaling for supporting the transmission schemes discussed below with reference to FIGS. 7-9 (e.g., including DCI messages for multi-TB scheduling with OCC) are shown and described in greater detail below with reference to FIG. 10.

FIG. 7 depicts a transmission scheme 700 that indicates OCC configurations separately for each TB scheduled to be transmitted by a given UE. More specifically, the DCI messages each schedule multiple TBs and indicate an OCC configuration to apply a single codeword (CW) to each of the scheduled TBs at a given UE. A DCI message may indicate an OCC configuration for scheduled TBs at respective multiplexed UEs to ensure orthogonality of data streams between the respective multiplexed UEs, thereby reducing interference. This provides the technical benefit of improving throughput at the UE (and one or more multiplexed UEs).

Transmission scheme 700 includes a first UE 704 and a second UE 706. Transmissions by the first UE 704 and the second UE 706 are multiplexed. A first DCI message (sometimes referred to herein as a “DCI indication”) 708 is sent to first UE 704 by a network entity. The first DCI message 708 includes a value that is used to indicate an OCC CW for all of the scheduled TBs (scheduled by the first DCI message 708) associated with first UE 704. As shown, the first DCI message 708 includes a value indicating an OCC CW “0” that is applied to each scheduled TB including a TB₁ 710 and a TB₂ 712. In some examples, the multiple TBs are scheduled for transmission over a NPUSCH. The OCC configuration indicated by DCI message 708 is thus maintained for each of the scheduled TBs (in this case TB₁ 710 and TB₂ 712) such that each of the scheduled TBs use the same OCC CW and OCC factor. The value that indicates OCC CW may include, for example, a bit or a set of bits.

Transmission scheme 700 also includes a second DCI message 714 sent to second UE 706 by the network entity to indicate a second OCC configuration. Second UE 706 may be associated with the second OCC configuration. For example, the second UE 706 may be associated with the indicated second OCC configuration such that the TBs scheduled for second UE 706 are scheduled and transmitted by second UE 706 in accordance with the indicated second OCC configuration. The second DCI message 714 includes a value that is used to indicate an OCC CW for all of the scheduled TBs (scheduled by the second DCI message 714) associated with second UE 706. As shown, the second DCI message 714 includes a value indicating an OCC CW “1” that is applied to each scheduled TB including a TB₁ 716 and a TB₂ 718. The OCC CW “1” indicated by second DCI message 714 is different from the OCC CW used for all of the scheduled TBs associated with first UE 704, thereby ensuring all of the scheduled TBs for the first UE 704 and all of the scheduled TBs for the second UE 706 are orthogonal to each other. In some examples, DCI messages 708,714 may include a bit or a set of bits that indicate an OCC CW to be applied to all of the scheduled TBs associated with either the first UE 704 or the second UE 706.

In some examples, DCI messages 708,714 may include one or more additional bits to indicate an OCC CW in the beginning of a NPUSCH transmission based on the OCC factor associated with the indicated OCC configuration. As discussed, an OCC factor refers to or indicates a length of an orthogonal cover code. The OCC factor may be denoted by M and may be greater than or equal to a number of UEs multiplexed. In some examples, OCC can increase duration of transmitted signals by a factor of M.

In some examples, the OCC configuration includes an OCC factor of 2 (e.g., including 2 total CWs to choose), thereby including a bit in the DCI message indicate each of the OCC CWs. In other examples, the OCC configuration includes an OCC factor of 4, thereby including a total of 2 bits in the DCI message to indicate the OCC CWs. In some examples, the values included within DCI messages 708, 714 may include one or more repurposed or reinterpreted bits use in conventional techniques for multi-TB scheduling using DCI messages. Accordingly, in certain aspects, the number of bits included within DCI messages 708, 714 may indicate an OCC configuration for each scheduled TB to reduce interference without use of additional bits or increasing the length of the DCI. This provides the technical benefit of improving throughput at the one or more multiplexed UEs without increasing overhead costs for DCI.

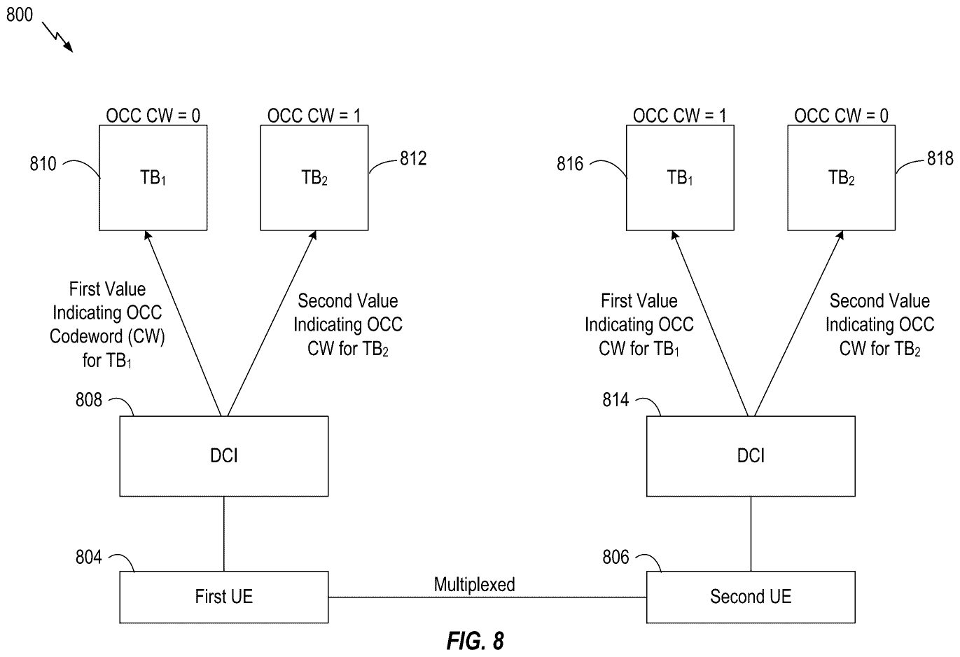

FIG. 8 depicts a diagrammatic view of a transmission scheme 800 that indicates an OCC configuration for each TB scheduled to be transmitted by a given UE. More specifically, the DCI message indicates an OCC configuration to apply a separate CW to each of the scheduled TBs at a given UE. The DCI message may indicate an OCC configuration for scheduled TBs at respective multiplexed UEs to ensure orthogonality of data streams between the respective multiplexed UEs, thereby reducing interference. This provides the technical benefit of improving throughput at the UE (and one or more multiplexed UEs). Using a DCI message to indicate individual CWs for each of the multiple scheduled transport blocks also increases flexibility in tailoring the CWs to each transport block, thereby providing the technical benefit of increasing link reliability due to improved mitigation of interference.

Transmission scheme 800 includes a first UE 804 and a second UE 806 that are multiplexed. A first DCI message 808 indicating an OCC configuration is sent to first UE 804 by a network entity. DCI message 808 includes a first value that indicates an OCC CW “0” for a TB₁ 710, and a second value that indicates an OCC CW “1” for a TB₂ 812. In some examples, the multiple TBs are scheduled for transmission over a NPUSCH. DCI messages 808 thus separately assigns an OCC configuration for each of the multiple scheduled TBs using individual values (in this case, a first bit for TB₁ 710 and a second bit for TB₂ 712) such that each TB has an individual OCC CW indication.

Transmission scheme 800 also includes a second DCI message 814 sent to second UE 806 by the network entity. DCI message 814 includes a first value that indicates an OCC CW “1” for a TB₁ 816, and a second value that indicates an OCC CW “0” for a TB₂ 818. DCI message 814 separately indicates OCC configurations for the scheduled TBs such that the indicated OCC CW for each scheduled TB associated with the second UE 806 (in this case TB₁ 816 and TB₂ 818) is orthogonal to the multiple scheduled TBs associated with first UE 804. In some examples, the OCC configurations indicated by DCI messages 808, 814 may alternate the indicated OCC CWs for each sequential TB, such as by alternating between a first OCC CW “0” and a second OCC CW “1”. In certain examples, DCI messages 808, 814 may include additional or fewer bits based on the OCC factor. In some examples, DCI messages 808, 814 may include 4 bits (e.g., for OCC 4) such that 2 of the bits may be used to indicate a first OCC CW for a first scheduled TB, and the remaining 2 bits may be used to indicate a second OCC CW for a second scheduled TB.

Accordingly, transmission scheme 800 enables use of a DCI message to indicate an OCC configuration for each scheduled TB including OCC CWs that create orthogonality between the scheduled TBs and additional scheduled TBs associated with one or more multiplexed UEs. This mitigates interference, thereby providing the technical benefit of improving throughput at the UE (and one or more multiplexed UEs). The DCI messages of transmission scheme 800 indicate an OCC configuration that creates time diversity by alternating CWs between transport blocks, thereby providing the technical benefit of improving reliability and mitigating fading effects due to different CWs experiencing varying channel conditions. The DCI messages of transmission scheme 800 indicating individual OCC CWs for each of the multiple scheduled transport blocks also increases flexibility in tailoring the CWs to each transport block, thereby providing the technical benefit of increasing link reliability due to improved mitigation of interference.

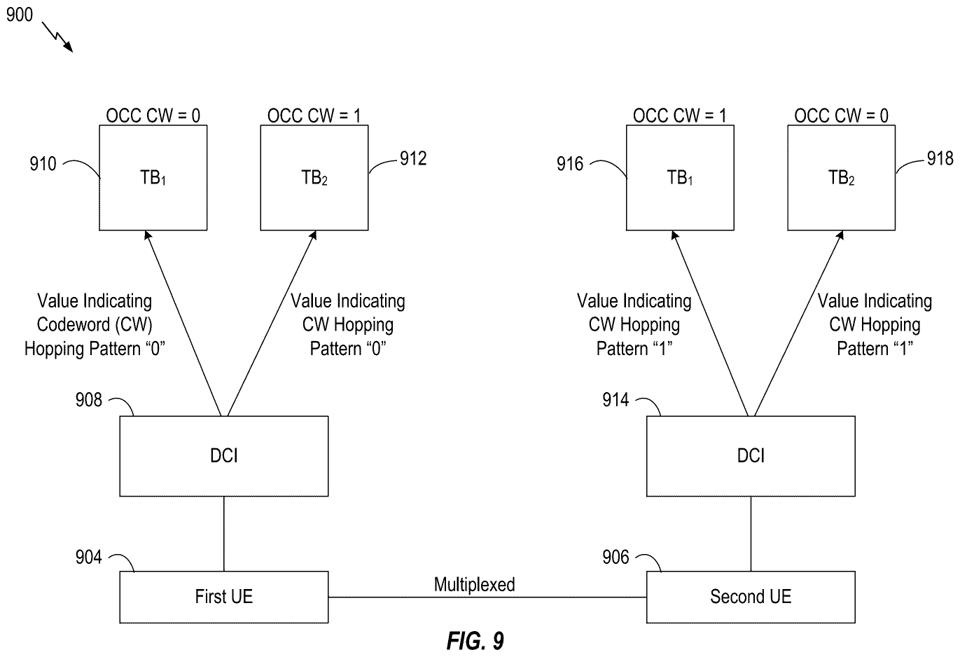

FIG. 9 depicts a diagrammatic view of a transmission scheme 900 that indicates an OCC CW hopping pattern to be applied to a set of TBs scheduled to be transmitted by a given UE. More specifically, the DCI message includes a value (e.g., one or more bits) for indicating an OCC CW hopping pattern. The OCC CW hopping pattern includes a sequence of OCC CWs that may be applied to each sequential TB in a set of multiple TBs being scheduled. Using a singular DCI message including a value that indicates a CW hopping pattern reduces the amount of signaling used to apply individual CWs to each of the scheduled TBs, thereby providing the benefit of reducing overhead. The OCC CWs applied to each schedule transport block in accordance with the indicated CW hopping pattern ensure orthogonality between the data stream of the UE and data streams of any additional multiplexed UEs. The DCI message thus reduces interference, thereby providing the technical benefit of improving throughput at the UE (and one or more multiplexed UEs).

Transmission scheme 900 includes a first UE 904 and a second UE 906 that are multiplexed. A first DCI message 908 indicating an OCC configuration is sent to first UE 904 by a network entity. DCI message 908 includes a value that indicates an OCC CW hopping pattern “0” for a TB₁ 910 and a TB₂ 912. In transmission scheme 900, OCC CW hopping pattern “0” assigns a sequence of OCC CWs, to multiple scheduled TBs, that alternates between a first OCC CW “0” and a second OCC CW “1” for each sequential scheduled TB of the multiple scheduled TBs.

Transmission scheme 900 also includes a second DCI message 914 sent to second UE 906 by the network entity. Second DCI message 914 indicates an OCC configuration for second UE 906. Second DCI message 914 includes a value that indicates an OCC CW hopping pattern “1” for a TB₁ 916 and a TB₂ 918. In transmission scheme 900, OCC CW hopping pattern “1” is used to assign a sequence of OCC CWs, to multiple scheduled TBs, that alternates between a first OCC CW “1” and a second OCC CW “0” for each sequential scheduled TB of the multiple scheduled TBs. Indicating an OCC CW hopping pattern allows for OCC CWs to be applied to multiple scheduled TBs at a given UE using only 1 bit as compared to transmission scheme 800 (discussed above with reference to FIG. 8) in which 1 bit is used per scheduled TB. Conversely, transmission scheme 800 may reduce configuration overhead (such as at an initial RRC configuration stage) relative to transmission scheme 900, since in transmission scheme 900, codeword hopping patterns may be configured prior to indication of a selected codeword hopping pattern. In certain aspects, such as for an OCC factor of 4, additional bits may be introduced to indicate additional available OCC CW hopping patterns.

Accordingly, DCI messages 908, 914 of transmission scheme 900 includes a value that indicates the codeword hopping pattern for OCC codewords to be applied to TBs scheduled by DCI messages 908, 914. Using a singular DCI message that indicates a codeword hopping pattern reduces the quantity of signaling as compared to signaling for assigning individual codewords to each of the scheduled transport blocks. This provides the technical benefit of reducing overhead. The OCC codewords applied to each schedule transport block in accordance with the indicated codeword hopping pattern ensure orthogonality between the data stream of the UE and data streams of any additional multiplexed UEs. DCI messages in accordance with transmission scheme 900 thus reduce interference, thereby providing the technical benefit of improving throughput at the UE (and one or more multiplexed UEs). The DCI messages further indicate an OCC configuration that creates time diversity based on codeword hopping patterns that apply alternating codewords between transport blocks, thereby providing the technical benefit of improving reliability and mitigating fading effects due to different codewords experiencing varying channel conditions.

### EXAMPLE SIGNALING OF DOWNLINK CONTROL INFORMATION TO SCHEDULE MULTIPLE TRANSPORT BLOCKS WITH ORTHOGONAL COVER CODES

FIG. 10 depicts a process flow 1000 for communications in a network between a network entity 1002, a UE 1004. In certain aspects, signaling in accordance with process flow 1000 may enable multi-TB scheduling with OCC at UE 1004 for supporting the transmission schemes discussed above with reference to FIGS. 7-9. For example, process flow 1000 may enable network entity 1002 to send DCI messages to UE 1004 for scheduling multiple TBs with OCC, thereby ensuring orthogonality between data streams of UE 1004 and one or more multiplexed UEs. This provides the technical benefit of improving throughput at UE 1004 (and one or more multiplexed UEs) and reducing downlink overhead based on using a single DCI message to schedule multiple TBs.

In some aspects, the network entity 10002 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1004 may be an example of UE 104 depicted and described with respect to FIG. 1 or the UE 304 depicted and described with respect to FIG. 3. However, in other aspects, UE 1004 may be another type of wireless communications device and network entity 1002 may be another type of network entity or network node, such as those described herein. Note that any operations or signaling illustrated with dashed lines may indicate that that operation or signaling is an optional or alternative example.

At 1006, UE 1004 sends network entity 1002 an indication of one or more capabilities relating to multiplexing. In some examples, the indication may indicate whether UE 1004 supports phase-coherence capabilities of UE 1004. As used herein, “phase-coherent capabilities” refer to an ability or inability of a given UE to maintain a consistent phase relationship between multiple signals such that the signals align predictably for efficient multiplexing and decoding by a network entity. In certain aspects, UE 1004 indicates capabilities to support multiplexing in a RRC message to network entity 1002.

At 1008, network entity 1002 sends a signal that configures UE 1004 with one or more configurations for multi-TB scheduling based on capabilities of UE 1004. In some examples, the one or more configurations may indicate that multiple-TB scheduling is activated. In other examples the one or more configurations may indicate an OCC CW hopping pattern to be used for multiple scheduled TBs. In some examples, the one or more configurations may indicate one or more OCC configuration parameters for multi-TB scheduling, such as an OCC Factor M, and/or an indication of a transmission scheme, such as in accordance with transmission schemes 700, 800, or 900, described above with reference to FIGS. 7-9. In some examples, network entity 1002 may configure UE 1004 with the one or more configurations via one of an RRC, a DCI or a MAC-CE. In certain aspects, UE 1004 may be capable of employing multiple different transmission schemes for using DCI messages to schedule multiple TBs with OCCs. In other aspects, UE 1004 may receive one or more configurations from both a DCI message and an RRC and/or MAC-CE. In the case of receiving multiple signals including one or more configurations, UE 1004 may overwrite prior receptions of one or more configurations based on a subsequently received one or more configurations. Accordingly, the signal sent by network entity may configure UE 1004 with an indicated OCC configuration selected from one or more available OCC configurations based on capabilities of UE 1004 to utilize one or more of the previously described transmissions schemes.

At 1010, network entity 1002 sends UE 1004 a DCI message. The DCI message schedules multiple TBs and includes an indication of an OCC configuration for the scheduled TBs. In some examples, the DCI message may include a value that indicates an OCC configuration. The OCC configuration may indicate an OCC CW for applying to each of the multiple scheduled TBs of UE 1004. In other examples, the DCI message may include one or more bits that each indicate a respective OCC codeword to be applied to a respective TB of the multiple schedule TBs. In some examples, the DCI message may include one or more bits that indicate to UE 1004 an OCC CW hopping pattern for applying a sequence of OCC CWs to the multiple scheduled TBs. In other examples, UE 1004 may receive an indication of the OCC configuration within an RRC sent by network entity 1002.

At 1012, UE 1004 sends the multiple scheduled TBs to network entity 1002 in accordance with the received indication of the OCC configuration. For example, each scheduled transport block may be coded according to an OCC CW in accordance with the OCC configuration indicated by network entity 1002 at 1010 such as in accordance with any one of the transmission schemes described above.

Note that the process flow illustrated in FIG. 10 is described herein to facilitate an understanding of signaling of downlink control information to schedule multiple transport blocks with orthogonal cover codes, and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### EXAMPLE OPERATIONS OF A USER EQUIPMENT

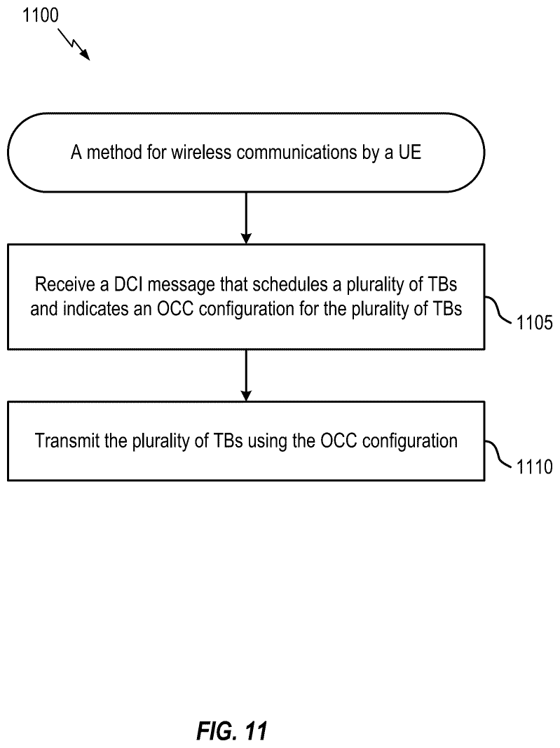

FIG. 11 shows a method 1100 for wireless communications by an apparatus, such as UE 104 of FIG. 1 or UE 304 of FIG. 3.

Method 1100 begins at block 1105 with receiving a DCI message that schedules a plurality of TBs and indicates an OCC configuration for the plurality of TBs. For example, the receiving of the DCI message that schedules a plurality of TBs and indicates an OCC configuration for the plurality of TBs could correspond to 1010 of FIG. 10.

Method 1100 then proceeds to block 1110 with transmitting the plurality of TBs using the OCC configuration. For example, the transmitting may correspond to 1012 of FIG. 10. Method 1100 may provide the technical benefit of enabling a UE to receive a DCI message that schedules multiple TBs with OCC, thereby ensuring orthogonality between data streams of the UE and one or more multiplexed UEs. This provides the technical benefit of improving throughput at the UE (and one or more multiplexed UEs) and reducing downlink overhead at the network entity.

In some aspects, the OCC configuration comprises at least an OCC codeword and an OCC factor.

In some aspects, the DCI message comprises a value indicating the OCC codeword for all TBs of the plurality of TBs.

In some aspects, the plurality of TBs are scheduled for a NPUSCH transmission.

In some aspects, the OCC configuration is a first OCC configuration that indicates an OCC codeword that provides orthogonality with a simultaneous transmission by a second UE associated with a second OCC configuration.

In some aspects, the DCI message indicating the OCC configuration for the plurality of TBs comprises a set of one or more bits, wherein each bit of the set of one or more bits indicates a respective OCC codeword for a respective TB of the plurality of TBs.

In some aspects, the OCC configuration for the plurality of TBs comprises a set of alternating OCC codewords.

In some aspects, the OCC configuration indicated by the DCI message comprises a codeword hopping pattern that indicates a sequence of OCC codewords for the plurality of TBs.

In some aspects, the DCI message comprises a set of one or more bits that indicate the codeword hopping pattern.

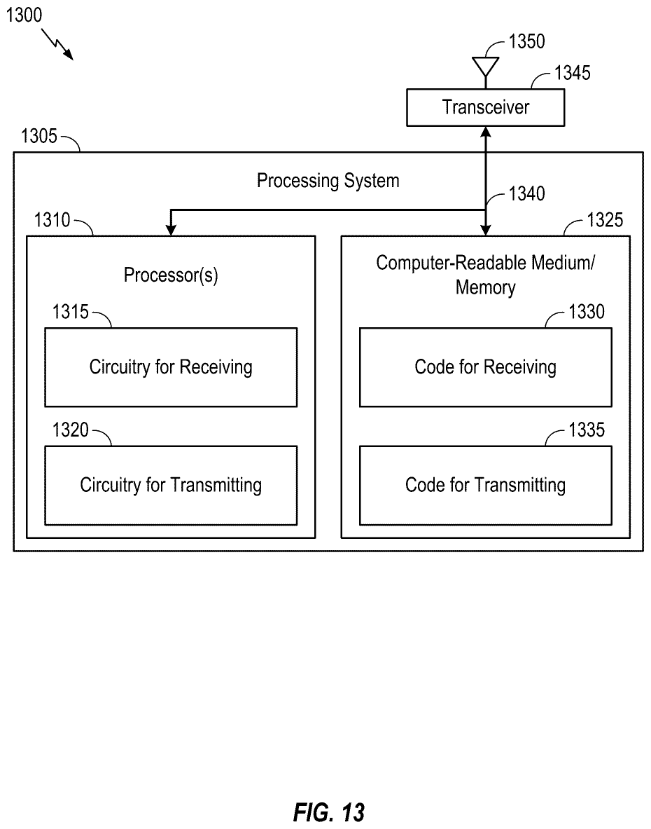

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### EXAMPLE OPERATIONS OF A NETWORK ENTITY

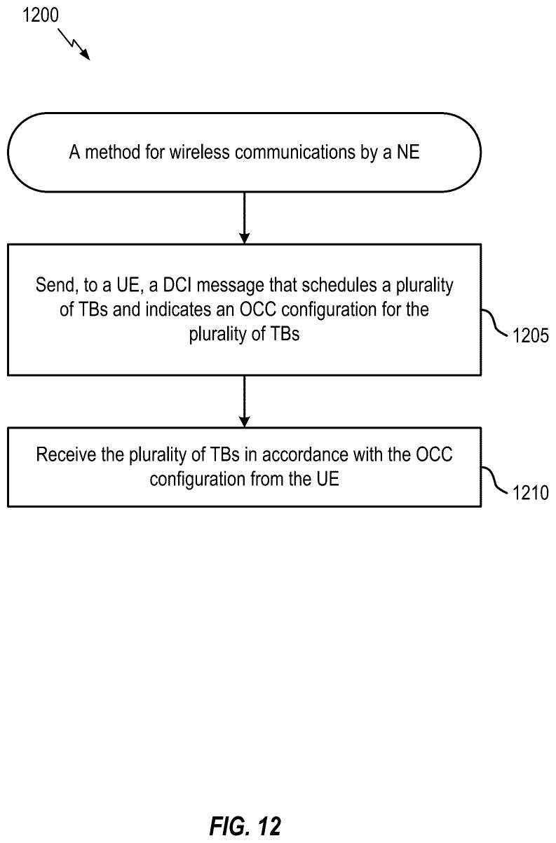

FIG. 12 shows a method 1200 for wireless communications by an apparatus, such as BS 102 of FIG. 1, a first network entity 300 or second network entity 302 of FIG. 3, or a disaggregated base station as discussed with respect to FIG. 2.

Method 1200 begins at block 1205 with sending, to a UE, a DCI message that schedules a plurality of TBs and indicates an OCC configuration for the plurality of TBs. For example, the sending of the DCI message that schedules a plurality of TBs and indicates an OCC configuration for the plurality of TBs could correspond to 1010 of FIG. 10.

Method 1200 then proceeds to block 1210 with receiving the plurality of TBs in accordance with the OCC configuration from the UE. For example, the receiving of the plurality of TBs in accordance with the OCC configuration may correspond to 1012 of FIG. 10. Method 1200 may provide the technical benefit of enabling a NE to send a DCI message that schedules multiple TBs with OCC, thereby ensuring orthogonality between data streams of the UE and one or more multiplexed UEs. This provides the technical benefit of improving throughput at the UE (and one or more multiplexed UEs) and reducing downlink overhead at the network entity.

In some aspects, the OCC configuration comprises at least an OCC codeword and an OCC factor.

In some aspects, the DCI message comprises a value indicating the OCC codeword for all TBs of the plurality of TBs.

In some aspects, the plurality of TBs are scheduled for a NPUSCH transmission.

In some aspects, the OCC configuration is a first OCC configuration that indicates an OCC codeword that provides orthogonality with a simultaneous transmission by a second UE associated with a second OCC configuration.

In some aspects, the UE is a first UE, the DCI message is a first DCI message, and the OCC configuration is a first OCC configuration, and wherein the method 1200 further comprises sending, to a second UE, a second DCI message that schedules a second plurality of TBs and indicates a second OCC configuration for the second plurality of TBs, the second OCC configuration indicating a second set of OCC codewords for the second plurality of TBs, wherein the second set of OCC codewords and a first set of OCC codewords of the first OCC configuration provide for a transmission of the second plurality of TBs to be orthogonal to a transmission of the plurality of TBs, and wherein the transmission of the second plurality of TBs and the transmission of the plurality of TBs are multiplexed in time.

In some aspects, the DCI message indicating the OCC configuration for the plurality of TBs comprises a set of one or more bits, wherein each bit of the set of one or more bits indicates a respective OCC codeword for a respective TB of the plurality of TBs.

In some aspects, the OCC configuration for the plurality of TBs comprises a set of alternating OCC codewords.

In some aspects, the OCC configuration indicated by the DCI message comprises a codeword hopping pattern that indicates a sequence of OCC codewords for the plurality of TBs.

In some aspects, the DCI message comprises a set of one or more bits that indicate the codeword hopping pattern.

In certain aspects, method 1200 further includes sending a RRC message that indicates an enabled OCC status for the UE.

In certain aspects, method 1200 further includes sending a radio resource control message to the UE that indicates one or more transmission schemes for the UE to communicate the plurality of TBs in accordance with the OCC configuration.

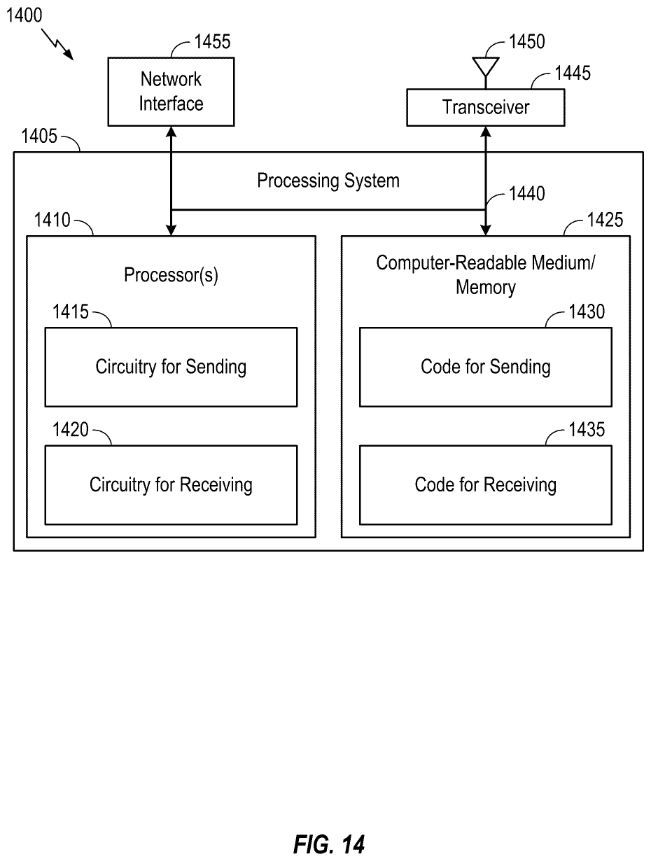

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### EXAMPLE COMMUNICATIONS DEVICES

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1345 (e.g., a transmitter and/or a receiver). The transceiver 1345 is configured to transmit and receive signals for the communications device 1300 via an antenna 1350, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, the one or more processors 1310 may be representative of the one or more processors 318 described with respect to FIG. 3. The one or more processors 1310 are coupled to a computer-readable medium/memory 1325 via a bus 1340. In some aspects, the computer-readable medium/memory 1325 may be representative of the one or more memories 320 described with respect to FIG. 3. The computer-readable medium/memory 1325 is a non-transitory computer-readable medium/memory. In certain aspects, the computer-readable medium/memory 1325 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1325 stores code (e.g., executable instructions), including code for receiving 1330 and code for transmitting 1335. Processing of the code 1330 and 1335 may enable and cause the communications device 1300 to perform the method 1100 described with respect to FIG. 11, or any aspect related to it. For instance, in some aspects, code for receiving 1330 includes code for receiving a DCI message that schedules a plurality of TBs and indicates an OCC configuration for the plurality of TBs. In some aspects, code for transmitting 1335 includes code for transmitting the plurality of TBs using the OCC configuration.

The one or more processors 1310 include circuitry configured to implement (e.g., execute) the code stored in the computer-readable medium/memory 1325, including circuitry for receiving 1315 and circuitry for transmitting 1320. Processing with circuitry 1315 and 1320 may enable and cause the communications device 1300 to perform the method 1100 described with respect to FIG. 11, or any aspect related to it. For instance, in some aspects, circuitry for receiving 1315 includes circuitry for receiving a DCI message that schedules a plurality of TBs and indicates an OCC configuration for the plurality of TBs. In some aspects, circuitry for transmitting 1320 includes circuitry for transmitting the plurality of TBs using the OCC configuration.

More generally, means for communicating, transmitting, sending or outputting for transmission may include the one or more transceivers 324, one or more antenna 322 and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, or a disaggregated base station as discussed with respect to FIG. 2.

The communications device 1400 includes a processing system 1405 coupled to a transceiver 1445 (e.g., a transmitter and/or a receiver) and/or a network interface 1455. The transceiver 1445 is configured to transmit and receive signals for the communications device 1400 via an antenna 1450, such as the various signals as described herein. The network interface 1455 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, one or more processors 1410 may be representative of the one or more processors 308, as described with respect to FIG. 3. The one or more processors 1410 are coupled to the computer-readable medium/memory 1425 via a bus 1440. In certain aspects, the computer-readable medium/memory 1425 is configured to store instructions (e.g., computer-executable code), including code 1430 and 1435, that when executed by the one or more processors 1410, cause the one or more processors 1410 to perform the method 1200 described with respect to FIG. 12, or any aspect related to it, including any operations described in relation to FIG. 12. The computer-readable medium/memory 1425 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1425 stores code (e.g., executable instructions), including code for sending 1430 and code for receiving 1435. Processing of the code 1430 and 1435 may enable and cause the communications device 1400 to perform the method 1200 described with respect to FIG. 12, or any aspect related to it. For instance, in some aspects, code for sending 1430 includes code for sending, to a UE, a DCI message that schedules a plurality of TBs and indicates an OCC configuration for the plurality of TBs. In some aspects, code for receiving 1435 includes code for receiving the plurality of TBs in accordance with the OCC configuration from the UE.

The one or more processors 1410 include circuitry configured to implement (e.g., execute) the code stored in the computer-readable medium/memory 1425, including circuitry for sending 1415 and circuitry for receiving 1420. Processing with circuitry 1415 and 1420 may enable and cause the communications device 1400 to perform the method 1200 described with respect to FIG. 12, or any aspect related to it. For instance, in some aspects, circuitry for sending 1415 includes circuitry for sending, to a UE, a DCI message that schedules a plurality of TBs and indicates an OCC configuration for the plurality of TBs. In some aspects, circuitry for receiving 1420 includes circuitry for receiving the plurality of TBs in accordance with the OCC configuration from the UE.

Various components of the communications device 1400 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14.

### EXAMPLE CLAUSES

Implementation examples are described in the following numbered clauses:
Clause 1: A method for wireless communications by a UE comprising: receiving a DCI message that schedules a plurality of TBs and indicates an OCC configuration for the plurality of TBs; and transmitting the plurality of TBs using the OCC configuration.
Clause 2: The method of Clause 1, wherein the OCC configuration comprises at least an OCC codeword and an OCC factor.
Clause 3: The method of Clause 2, wherein the DCI message comprises a value indicating the OCC codeword for all TBs of the plurality of TBs.
Clause 4: The method of any one of Clauses 1-3, wherein the plurality of TBs are scheduled for a NPUSCH transmission.
Clause 5: The method of any one of Clauses 1-4, wherein the OCC configuration is a first OCC configuration that indicates an OCC codeword that provides orthogonality with a simultaneous transmission by a second UE associated with a second OCC configuration.
Clause 6: The method of any one of Clauses 1-5, wherein the DCI message indicating the OCC configuration for the plurality of TBs comprises a set of one or more bits, wherein each bit of the set of one or more bits indicates a respective OCC codeword for a respective TB of the plurality of TBs.
Clause 7: The method of Clause 6, wherein the OCC configuration for the plurality of TBs comprises a set of alternating OCC codewords.
Clause 8: The method of any one of Clauses 1-7, wherein the OCC configuration indicated by the DCI message comprises a codeword hopping pattern that indicates a sequence of OCC codewords for the plurality of TBs.
Clause 9: The method of Clause 8, wherein the DCI message comprises a set of one or more bits that indicate the codeword hopping pattern.
Clause 10: A method for wireless communications by a NE comprising: sending, to a UE, a DCI message that schedules a plurality of TBs and indicates an OCC configuration for the plurality of TBs; and receiving the plurality of TBs in accordance with the OCC configuration from the UE.
Clause 11: The method of Clause 10, wherein the OCC configuration comprises at least an OCC codeword and an OCC factor.
Clause 12: The method of Clause 11, wherein the DCI message comprises a value indicating the OCC codeword for all TBs of the plurality of TBs.
Clause 13: The method of any one of Clauses 10-12, wherein the plurality of TBs are scheduled for a NPUSCH transmission.
Clause 14: The method of any one of Clauses 10-13, wherein the OCC configuration is a first OCC configuration that indicates an OCC codeword that provides orthogonality with a simultaneous transmission by a second UE associated with a second OCC configuration.
Clause 15: The method of any one of Clauses 10-14, wherein the DCI message indicating the OCC configuration for the plurality of TBs comprises a set of one or more bits, wherein each bit of the set of one or more bits indicates a respective OCC codeword for a respective TB of the plurality of TBs.
Clause 16: The method of Clause 15, wherein the OCC configuration for the plurality of TBs comprises a set of alternating OCC codewords.
Clause 17: The method of any one of Clauses 10-16, wherein the OCC configuration indicated by the DCI message comprises a codeword hopping pattern that indicates a sequence of OCC codewords for the plurality of TBs.
Clause 18: The method of Clause 17, wherein the DCI message comprises a set of one or more bits that indicate the codeword hopping pattern.
Clause 19: The method of Clause 14, wherein the UE is a first UE, the DCI message is a first DCI message, and the OCC configuration is a first OCC configuration, and wherein the method further comprises sending, to a second UE, a second DCI message that schedules a second plurality of TBs and indicates a second OCC configuration for the second plurality of TBs, the second OCC configuration indicating a second set of OCC codewords for the second plurality of TBs, wherein the second set of OCC codewords and a first set of OCC codewords of the first OCC configuration provide for a transmission of the second plurality of TBs to be orthogonal to a transmission of the plurality of TBs, and wherein the transmission of the second plurality of TBs and the transmission of the plurality of TBs are multiplexed in time.
Clause 20: The method of any one of Clauses 10-19, further comprising: sending a RRC message that indicates an enabled OCC status for the UE.
Clause 21: The method of any one of Clauses 10-20, further comprising: sending a radio resource control message to the UE that indicates one or more transmission schemes for the UE to communicate the plurality of TBs in accordance with the OCC configuration.
Clause 22: A method of wireless communication by a UE, comprising: receiving a DCI message that schedules a plurality of TBs and indicates an OCC configuration for the plurality of TBs; and transmitting the plurality of TBs using the OCC configuration.
Clause 23: One or more apparatuses, comprising: one or more memories comprising executable instructions; and one or more processors configured to execute the executable instructions and cause the one or more apparatuses to perform a method in accordance with any one of Clauses 1-22.
Clause 24: One or more apparatuses configured for wireless communications, comprising: one or more memories; and one or more processors, coupled to the one or more memories, configured to cause the one or more apparatuses to perform a method in accordance with any one of Clauses 1-22.
Clause 25: One or more apparatuses configured for wireless communications, comprising: one or more memories; and one or more processors, coupled to the one or more memories, configured to perform a method in accordance with any one of Clauses 1-22.
Clause 26: One or more apparatuses, comprising means for performing a method in accordance with any one of Clauses 1-22.
Clause 27: One or more non-transitory computer-readable media comprising executable instructions that, when executed by one or more processors of one or more apparatuses, cause the one or more apparatuses to perform a method in accordance with any one of Clauses 1-22.
Clause 28: One or more computer program products embodied on one or more computer-readable storage media comprising code for performing a method in accordance with any one of Clauses 1-22.
Clause 29: One or more apparatuses configured for wireless communications, comprising: a processing system that includes one or more processors and one or more memories coupled with the one or more processors, the processing system configured to cause the one or more apparatuses to perform a method in accordance with any one of Clauses 1-22.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive a downlink control information (DCI) message that schedules a plurality of transport blocks (TBs) and indicates an orthogonal cover code (OCC) configuration for the plurality of TBs; and
transmit the plurality of TBs using the OCC configuration.

2. The apparatus of claim 1, wherein the OCC configuration comprises at least an OCC codeword and an OCC factor.

3. The apparatus of claim 2, wherein the DCI message comprises a value indicating the OCC codeword for all TBs of the plurality of TBs.

4. The apparatus of claim 1, wherein the plurality of TBs are scheduled for a narrowband physical uplink shared channel (NPUSCH) transmission.

5. The apparatus of claim 1, wherein the OCC configuration is a first OCC configuration that indicates an OCC codeword that provides orthogonality with a simultaneous transmission by a second UE associated with a second OCC configuration.

6. The apparatus of claim 1, wherein the DCI message indicating the OCC configuration for the plurality of TBs comprises a set of one or more bits, wherein each bit of the set of one or more bits indicates a respective OCC codeword for a respective TB of the plurality of TBs.

7. The apparatus of claim 6, wherein the OCC configuration for the plurality of TBs comprises a set of alternating OCC codewords.

8. The apparatus of claim 1, wherein the OCC configuration indicated by the DCI message comprises a codeword hopping pattern that indicates a sequence of OCC codewords for the plurality of TBs.

9. The apparatus of claim 8, wherein the DCI message comprises a set of one or more bits that indicate the codeword hopping pattern.

10. An apparatus for wireless communications, comprising a processing system that includes one or more processors and one or more memories coupled with the one or more processors, the processing system configured to cause aa network entity (NE)to:
send, to a user equipment (UE), a downlink control information (DCI) message that schedules a plurality of transport blocks (TBs) and indicates an orthogonal cover code (OCC) configuration for the plurality of TBs; and
receive the plurality of TBs in accordance with the OCC configuration from the UE.

11. The apparatus of claim 10, wherein the OCC configuration comprises at least an OCC codeword and an OCC factor.

12. The apparatus of claim 11, wherein the DCI message comprises a value indicating the OCC codeword for all TBs of the plurality of TBs.

13. The apparatus of claim 10, wherein the plurality of TBs are scheduled for a narrowband physical uplink shared channel (NPUSCH) transmission.

14. The apparatus of claim 10, wherein the OCC configuration is a first OCC configuration that indicates an OCC codeword that provides orthogonality with a simultaneous transmission by a second UE associated with a second OCC configuration.

15. The apparatus of claim 10, wherein the DCI message indicating the OCC configuration for the plurality of TBs comprises a set of one or more bits, wherein each bit of the set of one or more bits indicates a respective OCC codeword for a respective TB of the plurality of TBs.

16. The apparatus of claim 15, wherein the OCC configuration for the plurality of TBs comprises a set of alternating OCC codewords.

17. The apparatus of claim 10, wherein the OCC configuration indicated by the DCI message comprises a codeword hopping pattern that indicates a sequence of OCC codewords for the plurality of TBs.

18. The apparatus of claim 17, wherein the DCI message comprises a set of one or more bits that indicate the codeword hopping pattern.

19. The apparatus of claim 11, wherein the processing system is configured to cause the NE to send a radio resource control message to the UE that indicates one or more transmission schemes for the UE to communicate the plurality of TBs in accordance with the OCC configuration.

20. A method of wireless communication by a user equipment (UE), comprising:
receiving a downlink control information (DCI) message that schedules a plurality of transport blocks (TBs) and indicates an orthogonal cover code (OCC) configuration for the plurality of TBs; and
transmitting the plurality of TBs using the OCC configuration.
